(19) United States
(12) Patent Application Publication
(10) Pub. No.: US 2015/0310462 A1
(43) Pub. Date: Oct. 29, 2015

(54) Research Method and System Using a Likert Scale

(71) Applicant: ALAN GARCIA, AUSTIN, TX (US)

(72) Inventor: ALAN GARCIA, AUSTIN, TX (US)

(21) Appl. No.: 14/694,963

(22) Filed: Apr. 23, 2015

Related U.S. Application Data
(63) Continuation of application No. 61/986,089, filed on Apr. 29, 2014.

(51) Int. Cl. G06Q 30/02

(52) U.S. Cl. CPC G06Q 30/0203

(57) ABSTRACT

A research system and method that determines the polarity or consensus of an issue by gathering and analyzing positions and opinions about the issue from respondents. The respondents provide a position expressed on a Likert scale, and an opinion through a narrative opinion. Based on the positive or negative status of the position and the opinion, a collection of statements categorized into opinion cases is formed. The respondents also provide a second position based on the opinion cases. In essence, an independent, anonymous second position on an initial position is gathered from each respondent. This creates a synergy of anonymous interaction between the respondents. The repetitive review of positions amongst the respondents helps form an enhanced picture on the issue, especially the polarity of the issue. The positions and opinions are also efficacious for matching respondents with one another based on stated positions and voting patterns.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a research system and method that determines the polarity or consensus of an issue by gathering and analyzing positions and opinions about the issue from respondents. A psychometric scale, such as a Likert scale, and a narrative opinion are utilized by the respondents to provide positions and opinions on the issue. After receiving positive or negative feedback from the initial response, a second response is expressed by the respondents through the Likert scale. The second response is also expressed through the Likert scale. This repetitive questioning enables slicing of the attitudes and beliefs of a population of respondents, which determines the polarity or consensus of the opinion and issue.

Typically, a Likert scale is a psychometric scale commonly involved in research that employs questionnaires for issue and topics. The Likert scale is the most widely used approach to scaling responses in survey research. The Likert scale is the sum of responses to several Likert items. The Likert items can include a positive or negative view of the issue at hand. These items are usually displayed with a visual aid, such as a series of radio buttons or a horizontal bar representing a simple scale.

The issue may have significance to a marketer trying to determine the attitudes of a population for a product or service. For example, measuring, analyzing, and monitoring the views, sentiments, and opinions of groups can be of great importance to many industries. For example, retailers or marketing agencies may wish to determine opinions of buyers on particular products, on a company's brand, on a new design, and the like.

It is known that the determination of the attitude of the population with respect to some topic, written in natural language opinion, is applicable to a wide range of applications involving natural language processing, computational linguistics, and text mining. This is of particular interest to businesses seeking to obtain the opinions of customers and other reviewers on their products and services. Opinions are often expressed on the Internet, social networks, blogs, e-forums, and in dedicated customer feedback pages of company websites.

In many instances, the polarity or the consensus of the population on an issue can be used to steer a product or service towards, or away from a consumer. However, the initial positions and opinions of the issue may not provide a complete picture of the held attitudes and beliefs; and thereby the polarity or consensus on the opinion and issue. A second response that forms a position on the results from the first position can be performed anonymously, whereby the respondents are not aware of each other's prior positions and identity. The second response can help slice up the response data to a more refined level.

Typically, there are five positions on the Likert scale: Strongly Agree, Agree, Neutral, Disagree, and Strongly Disagree. These positions may be effective for describing the positive or negative attitudes and beliefs of the respondents. From the amount of positive or negative feedback, an analyst can determine polarity or consensus on the issue.

For the foregoing reasons, there is a research system and method that determines the polarity or consensus of an issue to gauge a population of interconnected respondents with the use of a Likert scale and a narrative opinion. This enhances marketing, as an analyst can better understand attitudes and beliefs pertinent to a product or service.

Research systems and methods have been utilized in the past; yet none with the present delivery expediting characteristics of the present invention. See Patent No. WO2009058899; U.S. Pat. No. 6,477,504; and U.S. Pat. No. 8,650,023.

For the foregoing reasons, there is a research system and method that determines the polarity and consensus of an issue.

### SUMMARY

The present invention describes a research system and method that determines the polarity or consensus of an issue and corresponding opinions by gathering and analyzing positions and opinions about the issue from respondents. A psychometric scale, such as a Likert scale, and a narrative opinion are utilized by the respondents to provide positions and opinions on the issue. After receiving positive or negative feedback from the initial response, a second response is expressed by the respondents through the Likert scale. The second response is also expressed through the Likert scale. This repetitive questioning enables slicing of the attitudes and beliefs of a population of respondents, which determines the polarity or consensus of the issue and corresponding opinions.

In one possible embodiment, the research system and method determines the polarity or consensus of an issue by gathering and analyzing positions and opinions about the issue from respondents. The respondents provide a position expressed on a Likert scale, and an opinion through a narrative opinion. Based on the positive or negative status of the position and the opinion, a collection of statements categorized into opinion cases is formed.

In another embodiment, the respondents also provide a second position based on the opinion cases. In essence, an independent, anonymous second position on an initial position is gathered from each respondent. This creates a synergy of anonymous interaction between the respondents. The repetitive review of positions amongst the respondents helps form an enhanced picture on the issue, especially the polarity of the issue. The positions and opinions are also efficacious for matching respondents with one another based on stated positions and voting patterns.

The method may include the steps of: presenting the issue to the at least two respondents. The respondents form a population that interacts with each other. The respondents take the survey on a client terminal. The method may then comprise providing, by at least two respondents, the position on the issue, the position configured to be expressed on a Likert scale. The Likert scale is used to determine if the position for the issue is positive or negative. The Strongly Agree and the Agree positions are considered Positive Issue Positions by the respondents.

The method may then include a step of providing by the at least two respondents, the opinion on the issue, the opinion configured to be expressed as a narrative. The issue comprises a social issue or question. The method then analyzes the position and the opinion to form an average issue opinion to form a respondent relationship map. The respondent relationship map may include a network graph of respondents that is formed based on the voting patterns across opinions. In this manner, the respondents can be segmented for analysis.

A next step includes analyzing the position and the opinion to derive at least two opinion cases, the at least two opinion cases comprising a range of positive and negative positions. The at least two opinion cases include a range of positive and negative positions based directly off the positions and opinions of the respondents. The opinion cases are derived by initially determining whether the position expressed on the Likert scale 206 is positive or negative.

A next step comprises presenting the at least two opinion cases to the at least two respondents, the at least two opinion cases configured to be anonymous, wherein each respondent is unaware of the position and opinion of the other respondents. Another step includes providing, by the at least two respondents, a second position based on the at least two opinion cases, the second position configured to be expressed on the Likert scale.

From the analysis of these opinions, a Positive Polar Opinion is formed if the Positive Polar Opinion comprises the Positive Issue Category having more positive opinion positions than negative opinion positions, and the Negative Issue Category having more negative opinion positions than positive opinion positions. With the Positive Polar Opinion those respondents with a positive issue position maintain a predominately positive opinion position while those respondents with a negative issue position maintain a predominately negative opinion position.

A final step includes determining a polarity of the issue based on the second position. The final categorized opinions can be used to better understand consumers by a marketer. The categorized opinions can also help sell trademarks, products, and services, as marketing plans can be formulated based on known attitudes towards issues.

In summation, the research system and method is operable through a social opinion platform that presents an issue, such as a social or marketing related topic, to at least two respondents. The social opinion platform collects a position and an opinion on the issue from the respondents. The position is expressed on a Likert scale, while the opinion is expressed in a narrative statement. The position and opinion are categorized into at least two case opinions formed from the positive and negative favorability of each issue. These categories may be analyzed to better understand consumers by a marketer.

### DRAWINGS

These and other features, aspects, and advantages of the present invention will become better understood with regard to the following description, appended claims, and drawings where:

FIGS. 1A and 1B are flowcharts of an exemplary research method for determining a polarity of an issue;

FIG. 2 is a flowchart of an exemplary method for obtaining a voting pattern for positions and opinions;

FIG. 3 is a block diagram of a network infrastructure for an exemplary research system;

FIG. 4 is a block diagram of an exemplary respondent interacting with the research system; and

FIG. 5 is a block diagram depicting an exemplary client/server system which may be used by an exemplary web-enabled/networked embodiment of the present invention.

### DESCRIPTION

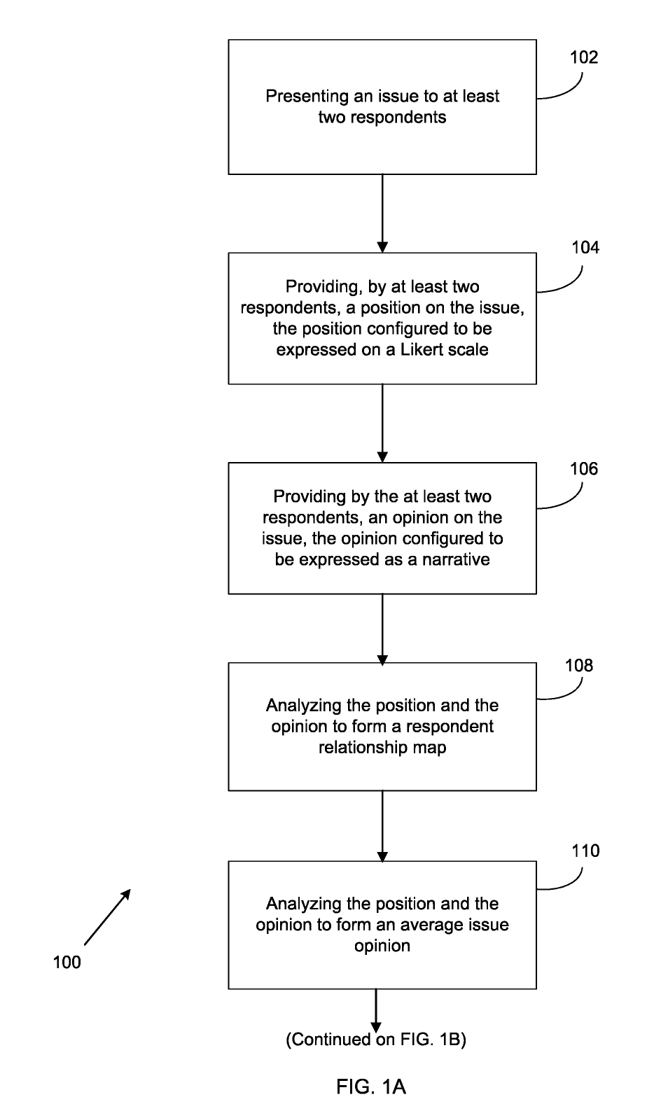

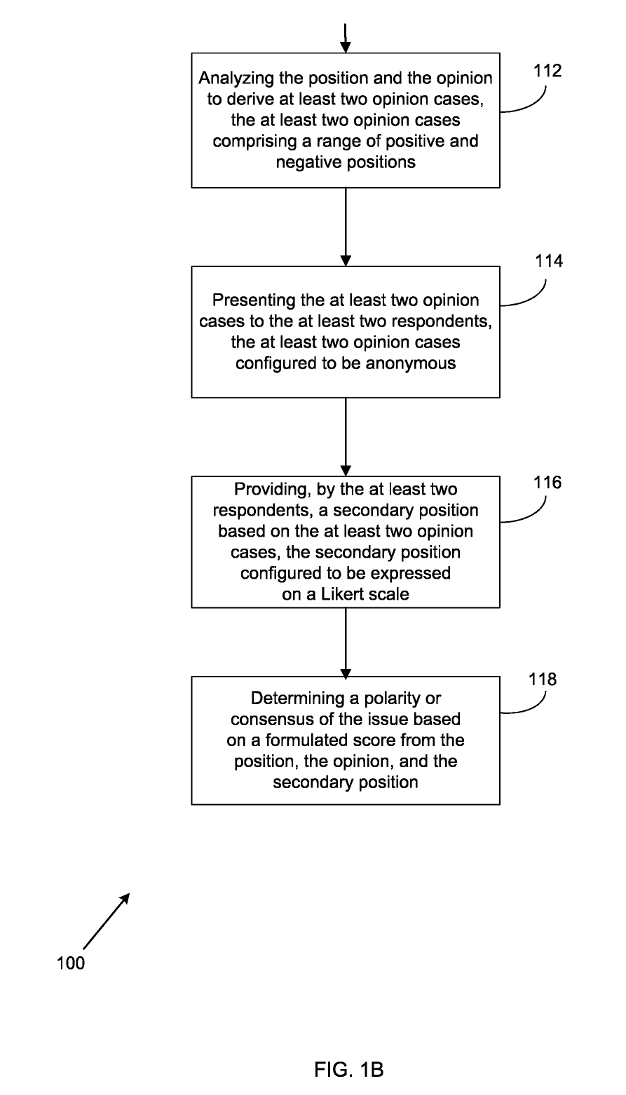

The present invention, described in FIGS. 1-4, is directed to a research system 300 and method 100 that determines the polarity or consensus of an issue by gathering and analyzing positions and opinions about the issue from at least two respondents. The respondents provide a position expressed on a Likert scale 206, and an opinion through a narrative opinion. Based on the positive or negative status of the position and the opinion, a collection of statements categorized into opinion cases is formed. The respondents also provide a second position based on the opinion cases. In essence, an independent, anonymous second position on an initial position is gathered from each respondent. This creates a synergy of anonymous interaction between the respondents. The repetitive review of positions amongst the respondents is a key metric that helps form an enhanced picture on the issue, especially the polarity of the issue. The positions and opinions are also efficacious for matching respondents with one another based on stated positions and voting patterns. In one embodiment, the research system and method 100 comprises a web based tool that gathers and analyzes responses from a Likert scale 206 and a narrative opinion to formulate an objective measurement of attitudes towards the issue. The attitudes are efficacious in determining the polarity or consensus on the issue.

In some embodiments, the research system and method 100 is operable through a social opinion platform that presents an issue, such as a social or marketing related topic, to at least two respondents. The social opinion platform collects a position and an opinion on the issue from the respondents. The position is expressed on a Likert scale 206, while the opinion is expressed in a narrative statement. The position and opinion are categorized into at least two case opinions formed from the positive and negative favorability of each issue. The respondents then provide a second position on the case opinions. The second position involves voting on the first position and opinion on the Likert scale 206. During the second vote, the case opinions remain anonymous, such that each respondent is unaware of the identity of the other respondents or the positions and opinions of the other respondents while voting on the second position. The position may then be quantified into scores that are used in conjunction with each respondent's topical second position to calculate a polarity or consensus of the issue and corresponding opinions. Additionally, the research system and method 100 matches the respondents with one another based on voting pattern of the positions and opinions. The matching of the respondents forms a respondent map that can help an analyst identify how the respondents cluster with one another based on general agreement or disagreement with the positions and opinions.

In one aspect of the present invention, referenced in FIG. 1, a research method 100 for determining the polarity or consensus of an issue by gathering and analyzing a position and an opinion of the issue from at least two respondents, comprises:

presenting the issue to the at least two respondents;

providing, by at least two respondents, the position on the issue, the position configured to be expressed on a Likert scale 206;

providing by the at least two respondents, the opinion on the issue, the opinion configured to be expressed as a narrative;

analyzing the position and the opinion to form a respondent relationship map;

analyzing the position and the opinion to form an average issue opinion;

analyzing the position and the opinion to derive at least two opinion cases, the at least two opinion cases comprising a range of positive and negative positions;

presenting the at least two opinion cases to the at least two respondents, the at least two opinion cases configured to be anonymous,

wherein each respondent is unaware of the position and opinion of the other respondents;

providing, by the at least two respondents, a second position based on the at least two opinion cases, the second position configured to be expressed on the Likert scale 206; and

determining a polarity of the issue based on the second position.

In a second aspect, the issue comprises a social or marketing related issue.

In another aspect, the issue is presented by a web based tool.

In another aspect, the at least two respondents comprise a networked set of client terminals.

In another aspect, the at least two respondents comprises a respondent population.

In another aspect, the at least two respondents perform a survey to respond to the issue.

In another aspect, the at least two respondents perform the survey at a client terminal.

In another aspect, the Likert scale 206 comprises five positions, the five positions comprising Strongly Agree, Agree, Neutral, Disagree, and Strongly Disagree.

In another aspect, the Strongly Agree and the Agree selected positions comprise a Positive Issue Category.

In another aspect, the Strongly Disagree and the Disagree selected positions comprise a Negative Issue Category.

In another aspect, the opinion comprises a narrative opinion, the narrative opinion comprising Strongly Agree, Agree, Neutral, Disagree, and Strongly Disagree.

In another aspect, the narrative opinion comprises four hundred words or less.

In another aspect, the at least two opinion cases comprise a collection of statements.

In another aspect, the at least two opinion cases comprise four opinion cases, the four opinion cases comprising a Positive Consensus Opinion 212, a Negative Consensus Opinion 218, a Positive Polar Opinion 216, and a Negative Polar Opinion 214.

In another aspect, the Positive Consensus Opinion 212 comprises the Positive Issue Category 208 having more positive opinion positions than negative opinion positions, and the Negative Issue Category 210 having more positive opinion positions than negative opinion positions.

In another aspect, the Negative Consensus Opinion 218 comprises the Positive Issue Category 208 having more negative opinion positions than positive opinion positions, and the Negative Issue Category 210 having more negative opinion positions than positive opinion positions.

In another aspect, the Positive Polar Opinion 216 comprises the Positive Issue Category 208 having more positive opinion positions than negative opinion positions, and the Negative Issue Category 210 having more negative opinion positions than positive opinion positions.

In another aspect, the Negative Polar Opinion 214 comprises the Positive Issue Category 208 having more negative opinion positions than positive opinion positions, and the Negative Issue Category 210 having more positive opinion positions than negative opinion positions.

In another aspect, the respondent relationship map comprises a graph.

In another aspect, the average issue opinion comprises the average of all issue positions provided by the respondent population.

In another aspect, the step of determining a polarity of the issue comprises generating and maintaining a Semantic Polarity Index for each issue.

In another aspect, the Semantic Polarity Index is configured to discern the polarity of the issue and how much of a conversation related to the issue is polarized.

FIG. 1 shows a flowchart diagram of the research method 100 for determining the polarity of an issue by gathering and analyzing positions and opinions of the issue from at least two respondents. The method 100 comprises an initial Step 102 of presenting an issue to at least two respondents. The issue comprises a social issue or question. In one example, the issue comprises gun control, and how far the Second Amendment can be applied. The issue of gun control can include survey questions and potential Likert responses, such as whether a respondent Strongly Agrees, Agrees, is Neutral, Disagrees, or Strongly Disagrees with the regulation of firearms in public places. From these responses, the position is determined to be positive or negative. A narrative opinion can also be given on the question of when and where guns can be caries and used, i.e., home protection, hunting, public display of firearms, and the like. The opinion is also determined to be positive or negative.

The method 100 may also include a Step 104 of providing, by at least two respondents, a position on the issue, the position configured to be expressed on a Likert scale 206. The Likert scale 206 is a form of a psychometric scale based on five positions, comprising Strongly Agree, Agree, Neutral, Disagree, and Strongly Disagree. The Strongly Agree and the Agree positions are considered Positive Issue Positions by the respondents. The Positive Issue Position forms a Positive Issue Category 208. Conversely, the Disagree and the Strongly Disagree positions are considered Negative Issue Positions by the respondents. The Negative Issue Position forms a Negative Issue Category 210.

Those skilled in the art, in light of the present teachings, will recognize that the Likert scale 206 is a psychometric scale commonly involved in research that employs surveys, often in the form of questionnaires. The Likert scale 206 is widely used to scale responses in survey research. The Likert scale 206 is considered symmetric because there are equal numbers of positive and negative positions, i.e., Strongly Agree, Agree, Neutral, Disagree, and Strongly Disagree. The distance between each position is generally equidistant. However, in other embodiments, seven or nine positions may be utilized for the present invention. Additionally, the values assigned each position are generally arbitrary, being assigned by the survey designer, which in this case may be the server for the research system. This flexibility in presentation and scoring of the Likert scale 206 allows for accommodation for the diverse types of issues.

A Step 106 may include providing by the at least two respondents, an opinion on the issue. In some embodiments, the opinion is configured to be expressed as a narrative. The opinion may include a narrative or statement on the issue. In one embodiment, the opinion includes a four hundred or less word narrative. Similar to the position provided by the respondents, the opinion can include a Positive Opinion Position and a Negative Opinion Position.

In some embodiments, a Step 108 includes analyzing the position and the opinion to form a respondent relationship map. The respondent relationship map may include a network graph of respondents that is formed based on the voting patterns across opinions. In this manner, the respondents can be segmented for analysis. In some embodiments, the respondent relationship map may include a respondent graph, chart, bar graph, or other visual metric that can help an analyst identify how respondents cluster with one another based on a general agreement or disagreement with other opinions. The capacity to map the relationship of the issues and opinions from the respondents may have the potential to influence or inform how meetings and agendas around the issues are structured. In this manner, the research method 100 is effective in turning sentiments and opinions into useful evidence for framing decisions and discussions.

In some embodiments, a Step 110 may include analyzing the position and the opinion to form an average issue opinion. The average issue position comprises the average of all issue positions provided by the respondent population. For example, if three respondents provide a Strongly Agree Position, and three different respondents provide a Disagree Position, the average issue opinion may be an Agree Position. The average issue position is yet another metric tool for determining the polarity or consensus on the issue, along with what the respondents feel about the issue.

A Step 112 comprises analyzing the position and the opinion to derive at least two opinion cases. The at least two opinion cases include a range of positive and negative positions based directly off the positions and opinions of the respondents. The opinion cases are derived by initially determining whether the position expressed on the Likert scale 206 is positive or negative. The positive or negative result from the Likert scale 206 forms either a Positive Issue Category 208, or a Negative Issue Category 210. The Positive Issue Category 208 or Negative Issue Category 210 is used in conjunction with the subsequent positive or negative opinion to formulate the at least two case opinions.

In one embodiment, the at least two opinion cases comprise four opinion cases, including, without limitation, a Positive consensus opinion 212, a Negative consensus opinion 218, a Positive polar opinion 216, and a Negative polar opinion 214.

The Positive consensus opinion 212 comprises the Positive Issue Category 208 having more positive opinion positions than negative opinion positions, and the Negative Issue Category 210 having more positive opinion positions than negative opinion positions.

The Negative consensus opinion 218 comprises the Positive Issue Category 208 having more negative opinion positions than positive opinion positions, and the Negative Issue Category 210 having more negative opinion positions than positive opinion positions.

The Positive polar opinion 216 comprises the Positive Issue Category 208 having more positive opinion positions than negative opinion positions, and the Negative Issue Category 210 having more negative opinion positions than positive opinion positions.

The Negative polar opinion 214 comprises the Positive Issue Category 208 having more negative opinion positions than positive opinion positions, and the Negative Issue Category 210 having more positive opinion positions than negative opinion positions.

In some embodiments, the method 100 provides a Step 114 of presenting the at least two opinion cases to the at least two respondents. The at least two opinion cases are configured to be anonymous, wherein each respondent is unaware of the position and opinion of the other respondents. This anonymous presentation enhances the integrity of the research method 100 since each potential position from each respondent is completely independent from influence by other respondents. In some embodiments, a Step 116 includes providing, by the at least two respondents, a second position based on the at least two opinion cases. The second position is the response from the at least two respondents, either positive or negative, expressed on the Likert scale 206. The same Likert scale 206 utilized for the position can also be used for the second position. In this manner, the position and the opinion provide data that allows for the analysis of the issue, such that votes for the opinion can be grouped into the Positive Issue Category 208 and a Negative Issue Category 210. The Positive Issue Category 208 and a Negative Issue Category 210 are then sliced by opinion agreement values from the second position.

A final Step 118 comprises deriving a polarity or consensus of the issue and corresponding opinions based on a formulated score from the position, the opinion, and the secondary position. Once the polarity or consensus is determined, the result displays for the respondents and/or the analyst. In some embodiments, the research method 100 assumes the input text is an opinion with a strongly defined context of the issue. The opinion defines polarity with respect to the issue and in relation to consensus with the at least two opinion cases. Consequently, a statistical framework is provided for the mechanical analysis of topical polarization amongst groups of respondents on the internet. In one embodiment, the step of determining a polarity of the issue may include generating and maintaining a Semantic Polarity Index for each issue. Those skilled in the art will recognize that the Semantic Polarity Index is a type of a rating scale designed to measure the connotative meaning of objects, events, and concepts. The connotations are used to derive the attitude towards the given object, event or concept. In the present invention, the Semantic Polarity Index is configured to discern the polarity of the issue and how much of a conversation related to the issue is polarized.

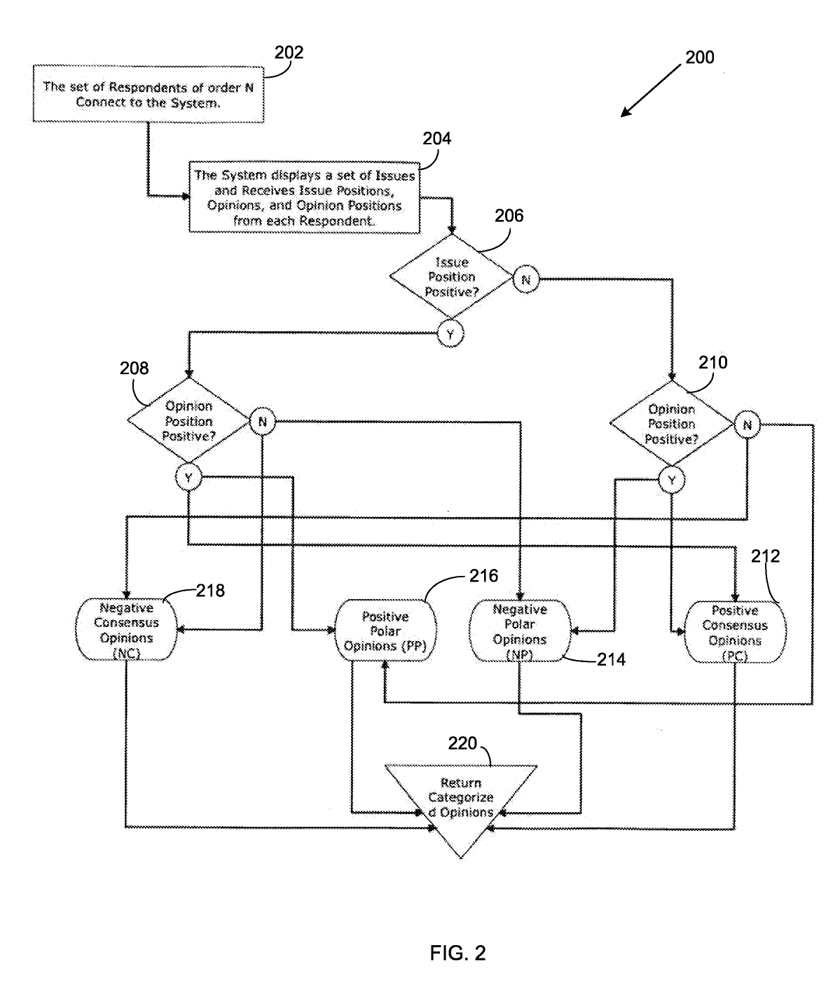

As referenced in FIG. 2, a method 200 for categorizing the issues and opinions collects positions on issues and statements related to them from respondents, collects each respondent's reactions to all other respondents' statements, and returns a collection of statements for each issue sorted by four categories of polarity. The positive or negative results of the positions and the opinions work in conjunction to form a Positive Issue Category 208 and a Negative Issue Category 210. The at least two opinion cases are determined by various combinations of the Positive Issue Category 208 and the Negative Issue Category 210 in conjunction with the positive and negative feedback from position and the opinion.

The method 200 comprises an initial Step 202 of the respondents of order N connecting to the system 300. The respondents form a population that interacts with each other. The respondents take the survey on a client terminal. A next Step 204 comprises the system displaying a set of issues and receiving issue positions and opinions form each respondent. The issue comprises a social issue or question. In some embodiments, the method 200 may utilize the Likert scale 206 to determine if the position for the issue is positive or negative. The Strongly Agree and the Agree positions are considered Positive Issue Positions by the respondents.

From the results of the Likert scale 206, a Positive Issue Category 208 is formed if the position is positive. However, a Negative Issue Category 210 is formed if the position is negative. The position and the opinion provide data that allows for the analysis of the issue, such that votes for the opinion can be grouped into the Positive Issue Category 208 and the Negative Issue Category 210. The Positive Issue Category 208 and the Negative Issue Category 210 are then sliced by opinion agreement values from the second position.

A Positive consensus opinion 212 is formed if the Positive Issue Category 208 has more positive opinion positions than negative opinion positions, and the Negative Issue Category 210 having more positive opinion positions than negative opinion positions. With the Positive Consensus Opinion 212, those respondents with a positive issue position, and those respondents with a negative issue position, share a predominately positive opinion position.

Positive Consensus Opinion 212 comprises:

Strongly Support+Support=>Σagrees>Σdisagrees

Undecided=>agrees>disagrees

Oppose+Strongly Oppose=>Σagrees>Σdisagrees

A Negative polar opinion 214 is formed if the Negative Polar Opinion 214 comprises the Positive Issue Category 208 having more negative opinion positions than positive opinion positions, and the Negative Issue Category 210 having more positive opinion positions than negative opinion positions. With the Negative Polar Opinion 214, those respondents with a positive issue position maintain a predominately negative opinion position while those respondents with a negative issue position maintain a predominately positive opinion position.

Negative Polar Opinion 214 comprises:

Strongly Support+Support=>Σagrees<Σdisagrees

Undecided=>Σagrees˜=Σdisagrees

Oppose+Strongly Oppose=>Σagrees>Σdisagrees

A Positive Polar Opinion 216 is formed if the Positive Polar Opinion 216 comprises the Positive Issue Category 208 having more positive opinion positions than negative opinion positions, and the Negative Issue Category 210 having more negative opinion positions than positive opinion positions. With the Positive Polar Opinion 216 those respondents with a positive issue position maintain a predominately positive opinion position while those respondents with a negative issue position maintain a predominately negative opinion position.

Positive Polar Opinion 216 comprises:

Strongly Support+Support=>Σagrees>Σdisagrees

Undecided=>Σagrees˜=Σdisagrees

Oppose+Strongly Oppose=>Σagrees<Σdisagrees

A Negative Consensus Opinion 218 is formed if the Negative Consensus Opinion 218 comprises the Positive Issue Category 208 having more negative opinion positions than positive opinion positions, and the Negative Issue Category 210 having more negative opinion positions than positive opinion positions. With the Negative Consensus Opinion 218, those respondents with a positive issue position, and those respondents with a negative issue position, share a predominately negative opinion position.

Negative Consensus Opinion 218 comprises:

Strongly Support+Support=>Σagrees<Σdisagrees

Undecided=>agrees<disagrees

Oppose+Strongly Oppose=>Σagrees<Σdisagrees

Additionally, the at least two cases opinions comprise a corner case based on a simple cross-Likert case analysis.

Corner Case comprises:

Strongly Support+Support=>Σagrees˜=Σdisagrees

Undecided=>Σagrees˜=Σdisagrees

Oppose+Strongly Oppose=>Σagrees˜=Σdisagrees

A final Step 220 comprises returning the categorized opinions 220 for display and further analysis. The final categorized opinions 220 can be used to better understand consumers by a marketer. The categorized opinions 220 can also help sell trademarks, products, and services, as marketing plans can be formulated based on known attitudes towards issues. For example, the caloric amount of a food item can be adjusted in different regions of a country, depending on the calorie tolerance of the population. Myriads other combinations of marketing analysis can be determined by the present method 200.

In one alternative embodiment the inequalities of the case opinions can be expressed as a bi-modal distribution with each mode skewed in inverse relation to one other in the case of polarity, and a uniform distribution in the case of consensus. Those opinions with the most consensus, as determined by the degree of uniformity and largeness of an agree/disagree ratio, may be of value towards positive compromise on these issues amongst general voter populations.

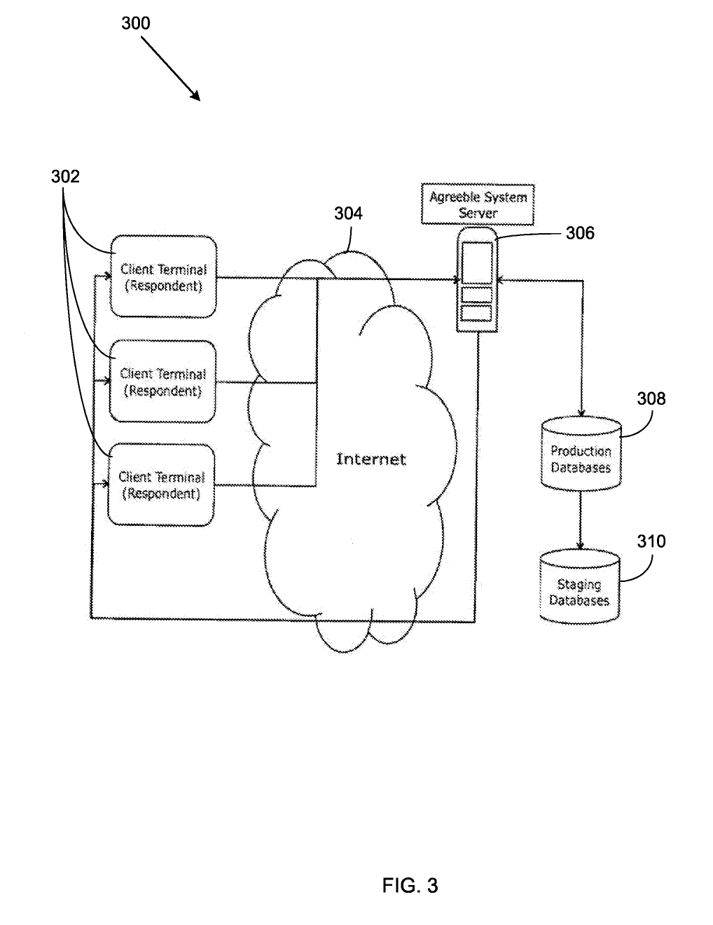

Turning now to FIG. 3, a research system 300 provides a Likert item for the respondents to provide a position to a predetermined question or issue topic. The research system 300 also provides an open ended textual opinions regarding the issue topic, and votes of agreement or disagreement with other respondents' provided textual opinions. This helps determine the polarity or consensus of an issue. The system 300 utilizes issue surveys, Likert scales 206, narrative opinions, a server 306, at least two client terminals 302, a production database 308, and a staging database 310. These components are interconnected through an Internet or a network 304. However, in other embodiments, the network infrastructure may include a cloud or an intranet.

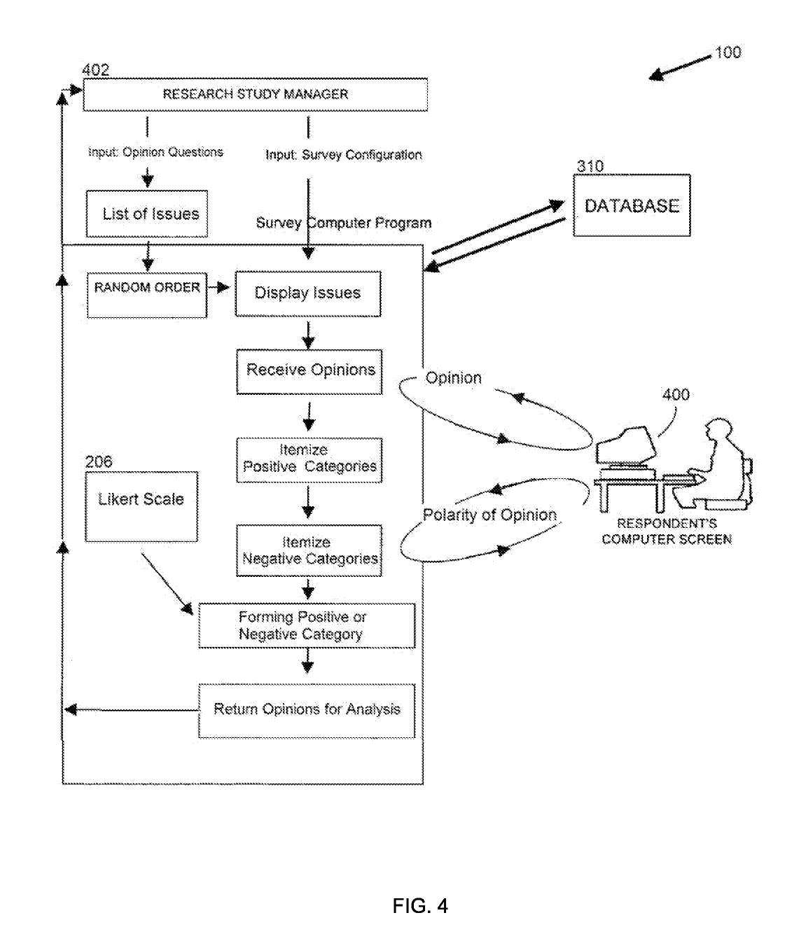

As referenced in FIG. 4, the at least two respondents perform the survey at the at least two client terminals 302. A research study manager 402 may observe and administer the research. The survey presents an issue having social or economic questions. The client terminals may include a computer display 400 that presents a plurality of Likert items for the respondents to select from. The computer display 400 may also present a blank space for the respondents to type in a narrative opinion.

In one embodiment, the staging database 310 provides an intermediate storage area used for data processing during the extract, transform and load process of the survey. The production database 308 may include a computer program to provide some form of artificial intelligence, which consists primarily of a set of rules for taking the survey. The rules may include using a specific Likert scale 206, timing the survey, and restricting access and information between each respondent.

In some embodiments, the client terminals 302 and the Internet or network 304 enable interaction between at least two respondents of the survey by collecting positions in the form of a Likert scale 206 for the issue, and opinion statements from each respondent around the issue. The server 306 categorizes the position and the opinion into at least two opinion cases. The server 306 also makes the opinion cases anonymous. The server 306 and the production database 308 work in conjunction to enable the respondents to perform a blind vote in agreement or disagreement of the opinion cases along the Likert scale 206. Finally, the server 306 determines the polarity or consensus of the issue based on the at least two opinion cases.

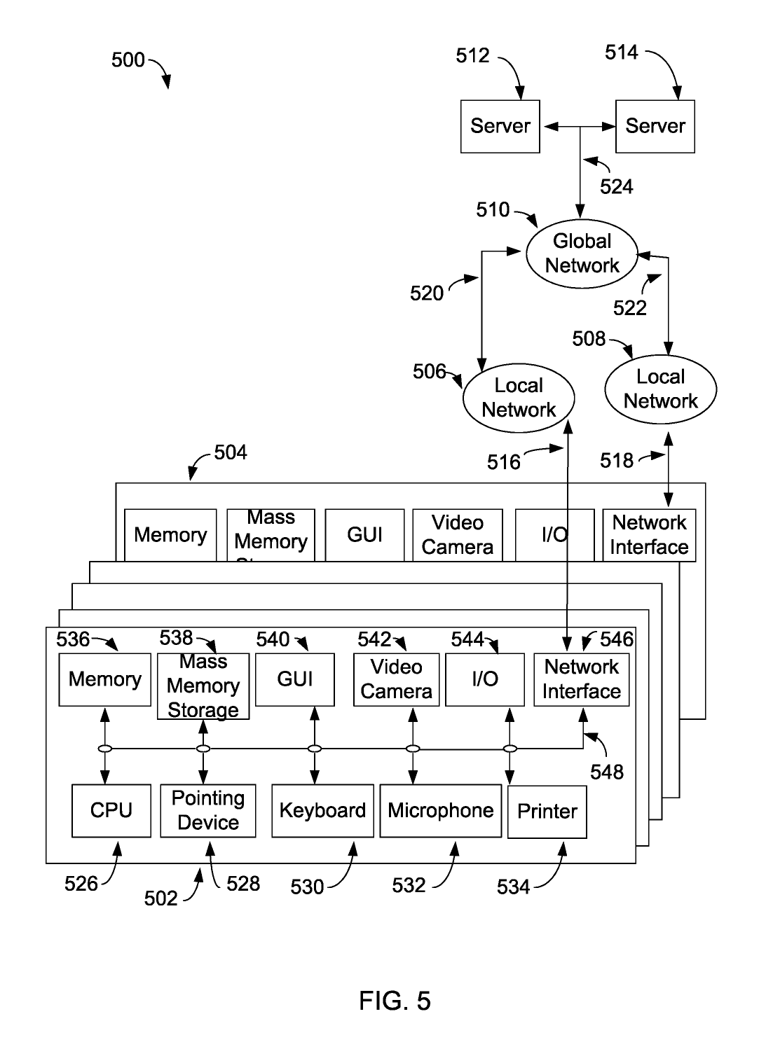

FIG. 5 is a block diagram depicting an exemplary client/server system which may be used by an exemplary web-enabled/networked embodiment of the present invention.

A communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof Many other variations are possible. For example, the research method 100 could utilize different types of scales to gather attitudes and opinions, such as psychometric scale. Accordingly, the scope should be determined not by the embodiments illustrated, but by the appended claims and their legal equivalents.

What is claimed is:

1. One or more computer storage media storing computer-usable instructions, that when used by one or more computing devices, cause the one or more computing devices to perform a research method for determining the polarity or consensus of an issue by gathering and analyzing a position and an opinion of the issue from at least two respondents, the research method comprising the steps of:
(a) presenting the issue to the at least two respondents;
(b) providing, by at least two respondents, the position on the issue, the position configured to be expressed on a Likert scale;
(c) providing by the at least two respondents, the opinion on the issue, the opinion configured to be expressed as a narrative;
(d) analyzing the position and the opinion to form a respondent relationship map;
(e) analyzing the position and the opinion to form an average issue opinion;
(f) analyzing the position and the opinion to derive at least two opinion cases, the at least two opinion cases comprising a range of positive and negative positions;
(g) presenting the at least two opinion cases to the at least two respondents, the at least two opinion cases configured to be anonymous, wherein each respondent is unaware of the position and opinion of the other respondents;
(h) providing, by the at least two respondents, a second position based on the at least two opinion cases, the second position configured to be expressed on the Likert scale; and
(i) determining a polarity of the issue based on the second position.

2. The method of claim 1, in which the issue comprises a social or marketing related issue.

3. The method of claim 2, in which the at least two respondents comprise a networked set of client terminals.

4. The method of claim 3, in which the at least two respondents perform the survey in at least two client terminals.

5. The method of claim 4, in which the Likert scale comprises five positions, the five positions comprising Strongly Agree, Agree, Neutral, Disagree, and Strongly Disagree.

6. The method of claim 5, in which the Strongly Agree and the Agree selected positions comprise a Positive Issue Category.

7. The method of claim 6, in which the Strongly Disagree and the Disagree selected positions comprise a Negative Issue Category.

8. The method of claim 7, in which the opinion comprises a narrative opinion, the narrative opinion comprising Strongly Agree, Agree, Neutral, Disagree, and Strongly Disagree.

9. The method of claim 8, in which the narrative opinion comprises four hundred words or less.

10. The method of claim 9, in which the at least two opinion cases comprise four opinion cases, the four opinion cases comprising a Positive Consensus Opinion, a Negative Consensus Opinion, a Positive Polar Opinion, and a Negative Polar Opinion.

11. The method of claim 10, in which the Positive Consensus Opinion comprises a Positive Issue Category having more positive opinion positions than negative opinion positions, and a Negative Issue Category having more positive opinion positions than negative opinion positions.

12. The method of claim 11, in which the Negative Consensus Opinion comprises the Positive Issue Category having more negative opinion positions than positive opinion positions, and the Negative Issue Category having more negative opinion positions than positive opinion positions.

13. The method of claim 12, in which the Positive Polar Opinion comprises the Positive Issue Category having more positive opinion positions than negative opinion positions, and the Negative Issue Category having more negative opinion positions than positive opinion positions.

14. The method of claim 13, in which the Negative Polar Opinion comprises the Positive Issue Category having more negative opinion positions than positive opinion positions, and the Negative Issue Category having more positive opinion positions than negative opinion positions.

15. The method of claim 14, in which the step of determining a polarity of the issue comprises generating and maintaining a Semantic Polarity Index for each issue.

16. The method of claim 15, in which the respondent relationship map comprises a graph.

17. A non-transitory program storage device readable by a machine tangibly embodying a program of instructions executable by the machine to perform a research method for determining the polarity or consensus of an issue by gathering and analyzing a position and an opinion of the issue from at least two respondents, the storage device comprising:
a) computer code presenting the issue to the at least two respondents;
b) computer code providing, by at least two respondents, the position on the issue, the position configured to be expressed on a Likert scale;
c) computer code providing by the at least two respondents, the opinion on the issue, the opinion configured to be expressed as a narrative;
d) computer code analyzing the position and the opinion to form a respondent relationship map;
e) computer code analyzing the position and the opinion to form an average issue opinion;
f) computer code analyzing the position and the opinion to derive at least two opinion cases, the at least two opinion cases comprising a range of positive and negative positions;
g) computer code presenting the at least two opinion cases to the at least two respondents, the at least two opinion cases configured to be anonymous, wherein each respondent is unaware of the position and opinion of the other respondents;
h) computer code providing, by the at least two respondents, a second position based on the at least two opinion cases, the second position configured to be expressed on the Likert scale; and
i) computer code determining a polarity of the issue based on the second position.

18. A research system for determining the polarity or consensus of an issue by gathering and analyzing a position and an opinion of the issue from at least two respondents, the research system comprising:
at least two client terminals configured to provide an issue and receive a response from at least two respondents;
a production database configured to regulate a set of rules for operating the survey;
a staging database configured to store the responses;
a server configured to determine a positive or negative result from the responses, the server further configured to determine the polarity or the consensus of the issue based on a Likert scale and a narrative opinion; and
an Internet configured to form a network for the system.

19. The system of claim 18, in which the Likert scale comprises five positions, the five positions comprising Strongly Agree, Agree, Neutral, Disagree, and Strongly Disagree.

20. The system of claim 19, in which the Strongly Agree and the Agree selected positions comprise a Positive Issue Category, and the Strongly Disagree and the Disagree selected positions comprise a Negative Issue Category.
